(19) United States
(12) Patent Application Publication
(10) Pub. No.: US 2012/0045734 A1
(43) Pub. Date: Feb. 23, 2012

(54) Dental Wedge Device With Guiding Wire

(76) Inventor: Hung M. Thai, San Jose, CA (US)

(21) Appl. No.: 12/861,591

(22) Filed: Aug. 23, 2010

(51) Int. Cl. A61C 3/00

(52) U.S. Cl. 433/149

(57) ABSTRACT

A dental wedge device for pulling between teeth. The device features a wedge component having a first end and a second end, the first end being generally pointed; and a generally flexible guiding wire. The guiding wire traverses the wedge component and the first end of the guiding wire extends from the first end of the wedge component and the second end of the guiding wire extends from the second end of the wedge component. In some embodiments, one or more knots are disposed along a portion of the guiding wire that traverses the wedge component.

### FIELD OF THE INVENTION

The present invention is directed to a dental tool, more particularly to a dental wedge for pushing the matrix band tight against the tooth structure, more particularly to a dental wedge comprising a guiding wire or string adapted to allow a dentist to pull the wedge in place.

### BACKGROUND OF THE INVENTION

When a patient has a tooth cavity/caries, a dentist uses dental hand piece and dental burs to remove all of the decayed tooth structure from the tooth. After removing caries, this tooth will have a cavity. The dentist will then place a dental matrix band around this cavity and fill it with dental filling materials. In addition to the matrix band, the dentist will use a dental wedge to push the bottom of the matrix band, which is right next to patient's gum/gingival tissue, tight against the tooth structure. This wedge will ensure that the dental materials will not leak or push outside of cavity margins. Generally, such wedges are pushed blindly between the teeth. Many times, the tip of the pointed wedge is jammed into the patient's gum, which causes trauma and often causes bleeding. In some cases pieces of the wedges break off in the patient's gum, leading to swelling and/or infection.

The present invention features a novel dental wedge device with a guiding wire (or string) extending from each side of the wedge. The guiding wire (or string) is adapted to allow the dentist to pull the wedge in place (e.g., in between teeth) rather than blindly push the wedge. After a procedure is complete, the dentist can easily remove the wedge using the guiding wire.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE DRAWINGS

FIG. 1 is a perspective view of the dental wedge device of the present invention.

FIG. 2 is a side view of the dental wedge device of FIG. 1.

FIG. 3 is a top view of the dental wedge device of FIG. 1.

FIG. 4 is a side cross sectional view of the dental wedge device of FIG. 3.

FIG. 5 is an in-use view of the dental wedge device of the present invention.

FIG. 6 is a perspective view of an alternative embodiment of the dental wedge device of the present invention.

FIG. 7 is a plurality of back cross sectional views of the dental wedge device of FIG. 1.

FIG. 8 is a top cross sectional view of the dental wedge device of FIG. 1.

### DESCRIPTION OF PREFERRED EMBODIMENTS

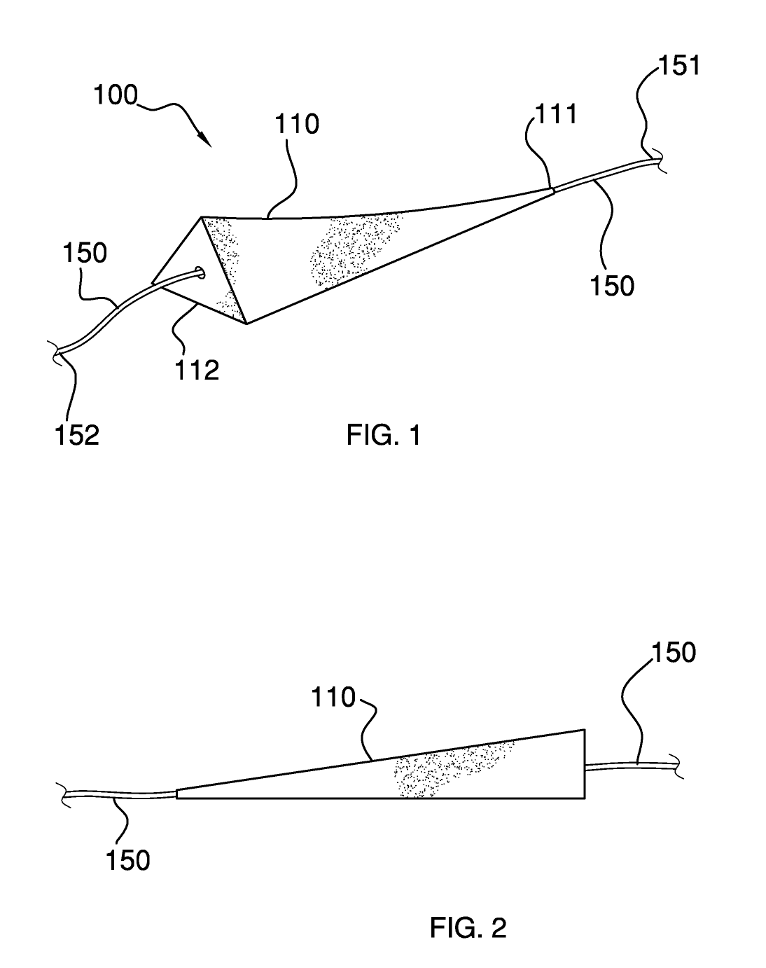

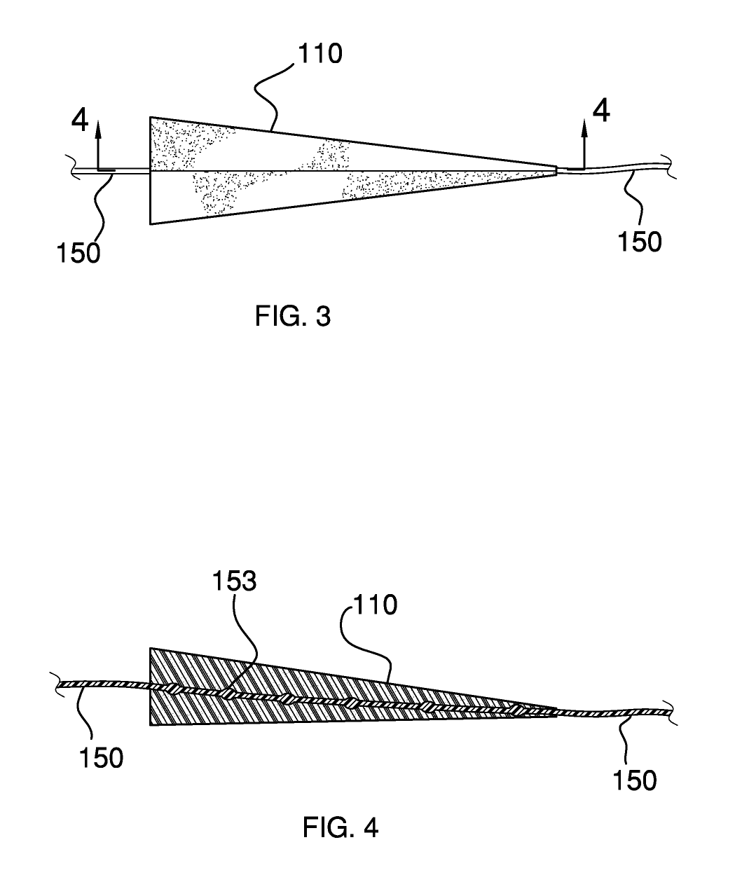

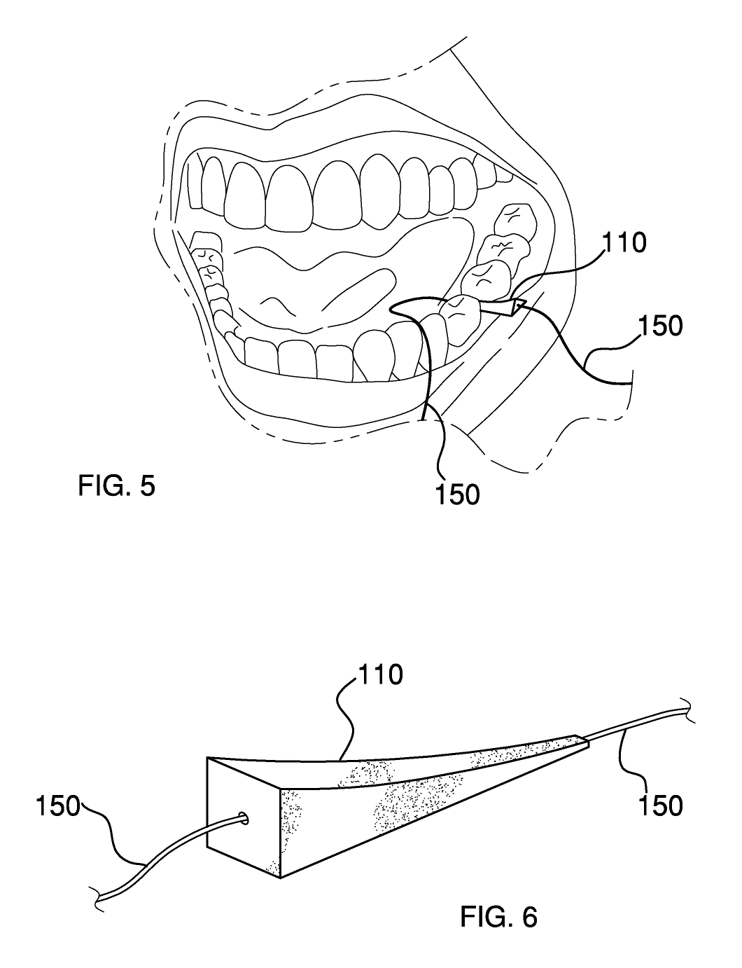

Referring now to FIG. 1-8, the present invention features a novel dental wedge device 100 with a guiding wire (or string) extending from each side of the wedge component. The guiding wire (or string) is adapted to allow the dentist to pull the wedge component of the wedge device 100 in place (e.g., in between teeth) rather than blindly push the wedge. After a procedure is complete, the dentist can easily remove the wedge component using the guiding wire (or string). Without wishing to limit the present invention to any theory or mechanism, it is believe that the wedge device 100 of the present invention can help prevent trauma and gum bleedings.

The wedge device 100 of the present invention features a wedge component 110 adapted to be wedged between teeth. The wedge component 150 has a first end 111 and a second end 112, the first end 111 being generally pointed. Shapes, and variations of wedges are well known to one of ordinary skill in the art. For example, the size (e.g., width) of wedges generally increases from its pointed end to its opposite end. In some embodiments, the first end has a smaller cross section area as compared to the second end. The wedge component 110 may be constructed in a variety of shapes and sizes. For example, in some embodiments, the wedge component 110 is a generally triangular wedge (e.g., see FIG. 1), for example the second end 112 of the wedge component 110 is generally triangular (e.g., as viewed from the back). The triangular wedge has a generally pointed first end 111, a generally triangularly shaped second end 112, a bottom surface, a first side surface, a second side surface, and a top edge (e.g., see FIG. 1). In some embodiments, the wedge component 110 is a generally rectangular (e.g., square) wedge (e.g., see FIG. 6), for example the second end of the wedge component 110 is generally rectangular (e.g., as viewed from the back). The rectangular wedge has a generally pointed first end 111, a generally rectangularly shaped second end 112, a bottom surface, a first side surface, a second side surface, and a top surface (e.g., see FIG. 1). The present invention is not limited to the aforementioned configurations and shapes.

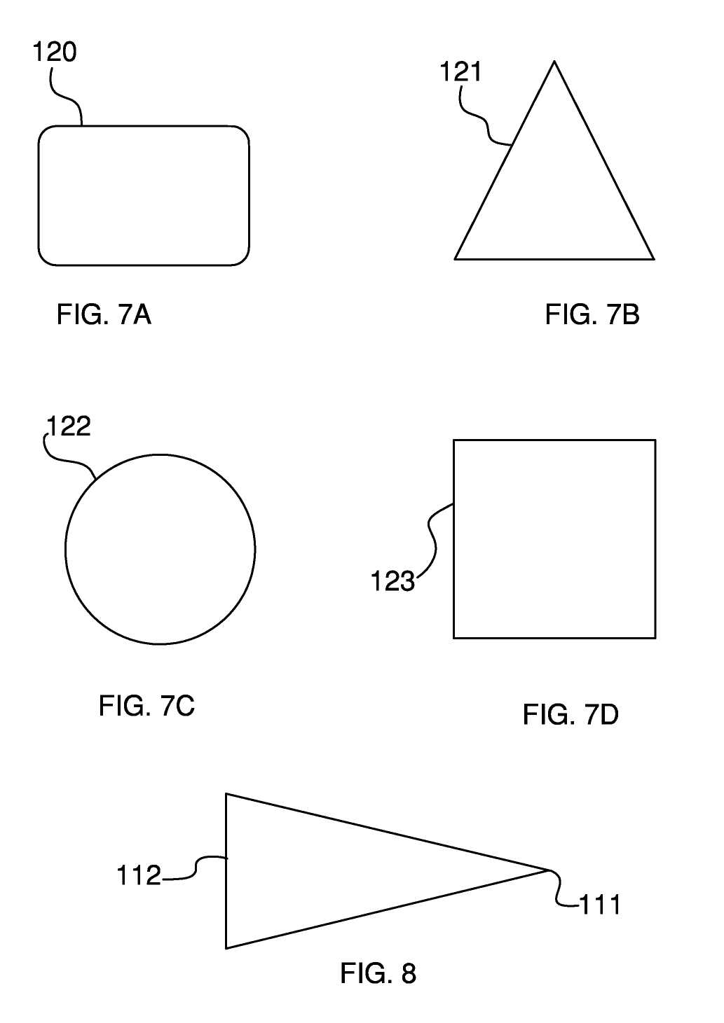

FIG. 4 shows a sagittal cross section of the wedge component 110. In some embodiments, the sagittal cross section of the wedge component 110 is generally triangular. In some embodiments, the transverse cross section of the wedge component 110 (e.g., as viewed from the second end 112 of the wedge component 110) is generally triangular. FIG. 7 shows examples of transverse cross sections of the wedge component 110 (e.g., as viewed from the second end 112 of the wedge component 110). In some embodiments, the transverse cross section of the wedge component 110 (e.g., as viewed from the second end 112 of the wedge component 110) is generally rectangular (e.g., square). In some embodiments, the transverse cross section of the wedge component 110 (e.g., as viewed from the second end 112 of the wedge component 110) is generally circular. FIG. 8 shows a top cross sectional view (e.g., coronal cross section) of the wedge component 110. In some embodiments, the coronal cross section of the wedge component 110 (e.g., as viewed from the top of the wedge component 110) is generally triangular.

The wedge component 110 may be constructed from a variety of materials and in a variety of sizes. For example, in some embodiments, the wedge component 110 is constructed from a material comprising rubber (e.g., a rubber composite), plastic, wood, the like, or a combination thereof. In some embodiments, the wedge component 110 is constructed from a material comprising a biodegradable material.

In some embodiments, the wedge component 110 is between about ¼ inch and ½ inch in length as measured from the first end 111 to the second end 112. In some embodiments, the wedge component 110 is between about ½ inch and ⅝ inch in length as measured from the first end 111 to the second end 112. In some embodiments, the wedge component 110 is between about ⅝ inch and ¾ inch in length as measured from the first end 111 to the second end 112. In some embodiments, the wedge component 110 is between about ¾ inch and 1 inch in length as measured from the first end 111 to the second end 112. In some embodiments, the wedge component 110 is between about ⅝ inch and 1 inch in length. The wedge component 110 is not limited to the aforementioned dimensions.

The wedge device 100 of the present invention further comprises a guiding wire 150 having a first end 151 and a second end 152. The first end 151 of the guiding wire extends from the first end 111 of the wedge component 110 and the second end 152 of the guiding wire 150 extends from the second end 112 of the wedge component 110. In some embodiments, the guiding wire 150 traverses the wedge component 110 (e.g., spans the inside of the wedge component 110 as shown in FIG. 4), and in some embodiments, the guiding wire 150 comprises a first half wire extending from the first end 111 of the wedge component 110 and a second half wire extending from the second end 112 of the wedge component 110.

The guiding wire 150 may be constructed from a variety of materials and in a variety of sizes. For example, the guiding wire 150 is not limited to a wire-like material (e.g., stainless steel) but may be constructed from a string material (e.g., cotton, nylon, e.g., nylon monofilament, etc.). The guiding wire 150 is generally flexible. In some embodiments, the guiding wire 150 is between about 3 to 4 inches in length (e.g., 3.5 inches) as measured from the first end 151 to the second end 152. In some embodiments, the guiding wire 150 is between about 4 to 5 inches in length as measured from the first end 151 to the second end 152. In some embodiments, the guiding wire 150 is between about 5 to 6 inches in length as measured from the first end 151 to the second end 152. In some embodiments, the guiding wire 150 is between about 6 to 10 inches in length as measured from the first end 151 to the second end 152. In some embodiments, the guiding wire 150 is between about 3 to 5 inches in length. In some embodiments, the guiding wire 150 is more than about 10 inches in length. The guiding wire 150 is not limited to the aforementioned dimensions.

As shown in FIG. 4, in some embodiments, one or more knots 152 (e.g., bulges) are disposed along the guiding wire 150, for example along the portion of the guiding wire 150, that traverses the wedge component 110. The knots 152 (e.g., bulges) may help provide strength and support to the guiding wire 150, for example helping to prevent the guiding wire 150 from sliding out of the wedge component 110.

As used herein, the term “about” refers to plus or minus 10% of the referenced number. For example, an embodiment wherein the guiding wire is about 5 inches in length includes a guiding wire that is between 4.5 and 5.5 inches in length.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

1. A dental wedge device comprising:
(a) a wedge component having a first end and a second end, the first end being generally pointed; and
(b) a guiding wire having a first end and a second end, the guiding wire traverses the wedge component and the first end of the guiding wire extends from the first end of the wedge component and the second end of the guiding wire extends from the second end of the wedge component.

2. The wedge device of claim 1, wherein the wedge component is a generally triangular wedge.

3. The wedge device of claim 1, wherein the wedge component is a generally rectangular wedge.

4. The wedge device of claim 1, wherein the wedge component is between about ¼ inch and ½ inch in length as measured from the first end to the second end.

5. The wedge device of claim 1, wherein the wedge component is between about ½ inch and ⅝ inch in length as measured from the first end to the second end. DOCKET NO.: THAI 10.01 PATENT

6. The wedge device of claim 1, wherein the wedge component is between about ⅝ inch and 1 inch in length as measured from the first end to the second end.

7. The wedge device of claim 1, wherein the guiding wire is constructed from a wire like material or a string material stainless steel.

8. The wedge device of claim 1, wherein the guiding wire is between about 3 to 5 inches in length as measured from the first end to the second end.

9. A dental wedge device comprising:
(a) a wedge component having a first end and a second end, the first end being generally pointed; and
(b) a generally flexible guiding wire having a first end and a second end, the first end extends from the first end of the wedge component and the second end extends from the second end of the wedge component.

10. The wedge device of claim 9, wherein the wedge component is a generally triangular wedge.

11. The wedge device of claim 9, wherein the wedge component is a generally rectangular wedge.

12. The wedge device of claim 9, wherein the wedge component is between about 1/4 inch and ½ inch in length as measured from the first end to the second end.

13. The wedge device of claim 9, wherein the wedge component is between about ½ inch and ⅝ inch in length as measured from the first end to the second end.

14. The wedge device of claim 9, wherein the wedge component is between about ⅝ inch and 1 inch in length as measured from the first end to the second end.

15. The wedge device of claim 9, wherein the guiding wire is constructed from stainless steel.

16. The wedge device of claim 9, wherein the guiding wire is between about 3 to 5 inches in length as measured from the first end to the second end.

17. (canceled)

18. The wedge device of claim 9, wherein the guiding wire comprises a first half wire extending from the first end of the wedge component and a second half wire extending from the second end of the wedge component.

19. The wedge device of claim 9 further comprising one or more knots disposed along a portion of the guiding wire that traverses the wedge component.

20. A dental wedge device comprising:
(a) a wedge component having a first end and a second end, the first end being generally pointed; and
(b) a guiding wire having a first end and a second end, the guiding wire traverses the wedge component and the first end of the guiding wire extends from the first end of the wedge component and the second end of the guiding wire extends from the second end of the wedge component, wherein one or more knots are disposed along a portion of the guiding wire that traverses the wedge component.
